(19) United States
(12) Patent Application Publication
(10) Pub. No.: US 2004/0015860 A1
(43) Pub. Date: Jan. 22, 2004

(54) In the development of computer programs, a method of recording the sequential development of each of a plurality of files forming the program

(75) Inventors: Julie Levell Craft, Austin, TX (US); Gerald Francis McBrearty, Austin, TX (US); Shawn Patrick Mullen, Buda, TX (US); Johnny Meng-Han Shieh, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 09/810,013

(22) Filed: Mar. 15, 2001

(51) Int. Cl. G06F 9/44

(52) U.S. Cl. 717/122

(57) ABSTRACT

Recording the history of the sequential development of each of the plurality of binary files forming the program by developing an initial version of a binary file, then developing a sequential plurality of subsequent changed versions of said binary file, assigning an identifier to each of the subsequent versions of the binary file and storing all of said identified versions of said binary file. The binary file identifiers are preferably binary identifiers, especially bar code identifiers. The assigning of a binary identifier to a version of a binary file is responsive to the completion of said version of said binary file and, preferably, is, thus, automatically responsive.

### TECHNICAL FIELD

The present invention relates to the development of computer programs and particularly to methods and programs which aid in the error tracking in and debugging of computer programs under development.

### BACKGROUND OF RELATED ART

Computer application programs are so widely used in business, industry and academic endeavors that they may be considered to be pervasive. There seems to be no end to the potential for computer program development. With the greatly increasing numbers of users for computers programmed to perform an infinite variety of services, the industry is continually striving to make application programs easier to use. However, in order to make programs easier to use at the consumer or user level, such programs must have more complex functional operations. Thus, today application programs are fairly complex and often require dozens of developers to collaborate on the final program. Any program up to an operating system can be broken down into dozens or hundreds of binary files. It is not unusual to have different developers work with different files in the same overall development of an application program. Different development personnel work on different sequential versions of any particular binary file. At the present time, with the rapid advance of group program development and, particularly, group programming over networks, it becomes increasingly difficult to debug programs and pinpoint errors. This is especially the case when the program is a complex application program or an operating system. A complex program could have hundreds of binary files, perhaps developed by dozens of people. Thus, when errors have occurred at a particular version of the program, it is often necessary to track through these hundreds of files.

These problems have become even more significant with expanded accessibility of virtually hundreds of programmers to each other in cooperative programming systems over networks and, particularly, the Internet. In such networked processes, developers coact to continuously expand and change programs in a distributed programming environment. These changes could range in complexity from minor “cosmetic” changes to new program subroutines to entire new programs. Depending on the type and nature of the program, every addition, subtraction or modification could have an insignificant or a profound effect on the program. At the present time, with object-oriented programming systems going full swing on the Internet, there could be hundreds of potential lesser or more significant changes to any particular program or program group. Actually, each change could be said to produce a new version of the program or routine. In this connection, object oriented software componentry permits more people to build software programs and routines and will shorten the software development cycle and make it more dynamic. Although the traditional software developers and administrators will continue to write the bulk of object oriented programs that are distributed and used over the Internet, the individual users will also be developing their own custom software since the object oriented development tools will be more readily available over the Internet and easier to use. It follows that as software will be combined in new, often unforeseen, ways, there is an increased likelihood that the individual developments will drive many of the programs into inoperable states for certain purposes or under certain conditions.

Accordingly, the program development technology is seeking implementations to make it easier for program developers and users to recover from software, modifications which did not operate as expected or which created problems with other related user software systems. U.S. Pat. No. 6,151,700, O. Fox et al., assigned to the assignee of the present invention, covers the expedient of identifying and saving only selected overall versions of application programs under development, but only when such versions meet predetermined criteria which trigger such a saving step.

### SUMMARY OF THE PRESENT INVENTION

The present invention offers a solution to satisfy the above-mentioned needs for tracking through multiple versions of each binary file in an application program by providing a method and program for recording the history of the sequential development of each of the plurality of binary files forming the program comprising: developing an initial version of a binary file, then developing a sequential plurality of subsequent changed versions of said binary file, assigning an identifier to the initial version and to each of the subsequent versions of the binary file and storing all of said identified versions of said binary file. The binary file identifiers are preferably binary identifiers, especially bar code identifiers. The assigning of a binary identifier to a version of a binary file is responsive to the completion of said version of said binary file and, preferably, is thus automatically responsive. Accordingly, when the application program is being subsequently debugged, the user is enabled to select one of the binary identifiers listed in a log and then access the binary file identified by said binary identifier in response to the selection of said identifier. In this manner, the user may select any of the multiple versions of multiple binary files in doing the debugging. The developer is further enabled to annotate said completed version of said binary file with comments. He is usually offered a dialog through which he may add any comment which may be of help to future users or debuggers.

Other objects, features and advantages of the present invention will be apparent from the accompanying drawings and from the detailed description below.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of an interactive data processor controlled display system suitable for the present invention;

FIG. 2 is a flowchart showing the development of the program of the present invention for providing a method and program for the development of computer programs and for the tracking and storing of all versions of the binary files which make up the program under development; and

FIG. 3 is a flowchart showing the running of the program described with respect to FIG. 2.

### DETAILED DESCRIPTION OF THE PREFERRED EMBODIMENT

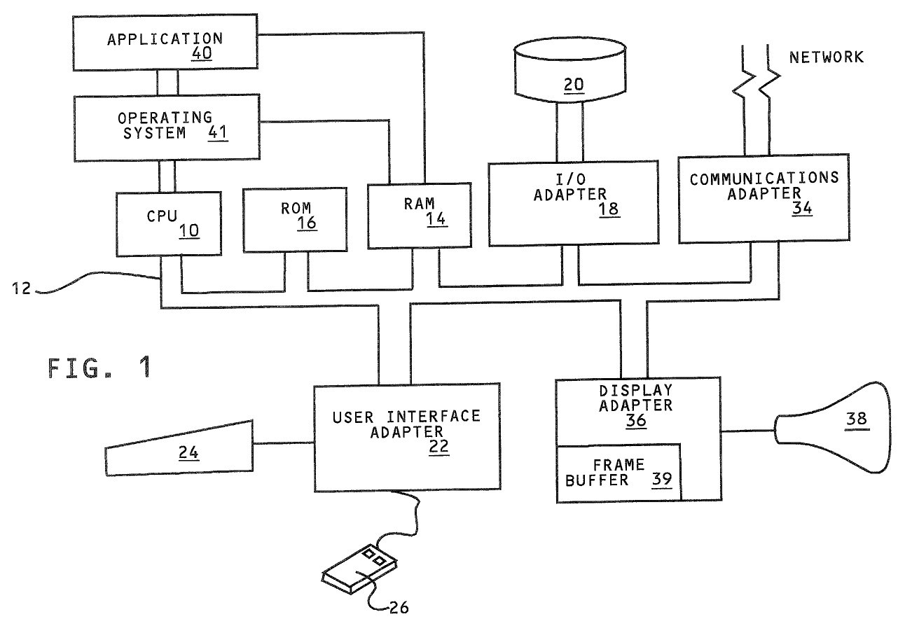

Referring to FIG. 1, a typical data processing system is shown which may function as the computer controlled display terminal used for the development of computer programs and for the tracking and storage of all versions of the binary files which make up the program under development.

A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; Microsoft's Windows98™ or WindowsNT™, as well as UNIX and AIX operating systems. Application programs 40, controlled by the system, are moved into and out of the main memory Random Access Memory (RAM) 14. These programs include the programs of the present invention for the development of computer programs and for the tracking and storing of all versions of all binary files in the programs. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over a Local Area Network (LAN) or a Wide Area Network (WAN), which includes, of course, the Web or Internet. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components; such as a digital to analog converter (not shown) and the like. By using the aforementioned I/O devices, a user is capable of inputting information to the system through the keyboard 24 or mouse 26 and receiving output information from the system via display 38 during the development of programs.

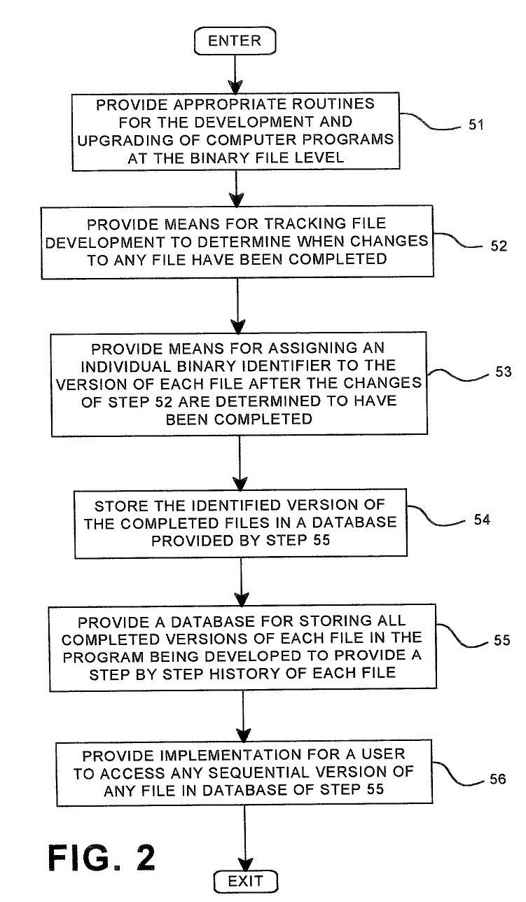

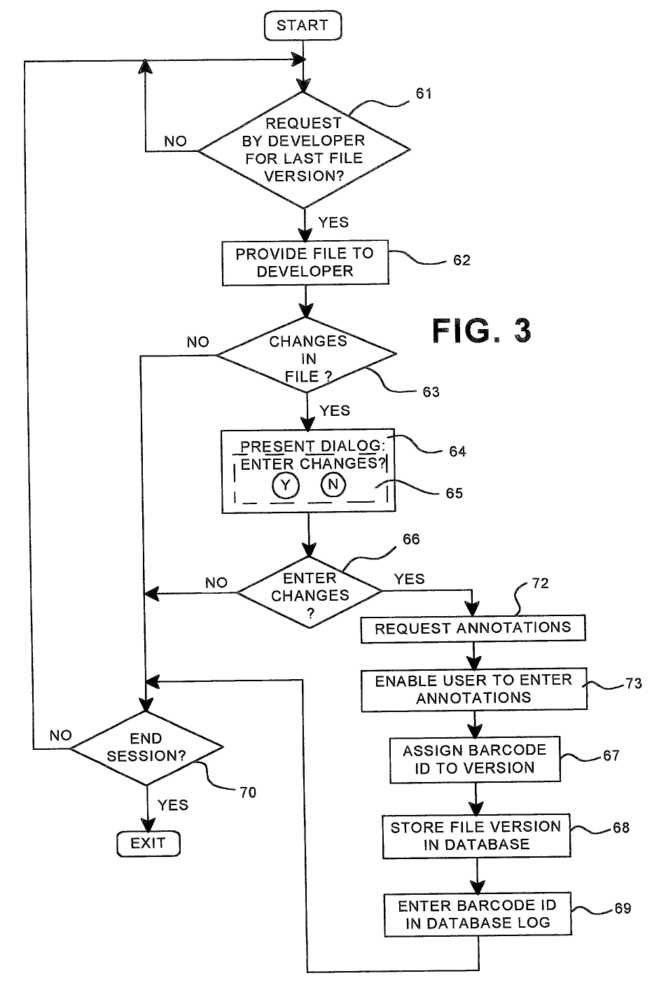

With this setup, the present invention will be subsequently described in greater detail with respect to FIGS. 2 and 3. FIG. 2 is a flowchart showing the development of a process according to the present invention for the development of computer programs and for the tracking and storing of all versions of all binary files in the programs. During the developmental process, appropriate routines are provided for the development and upgrading of the programs at the binary file levels, step 51. Means are provided for tracking file development to determine when changes to any file have been completed, step 52. Means are provided for assigning an individual binary identifier to the version of each file when the changes made to that file are completed, step 53. Means are provided for the storage of the identified versions of the completed files in a database provided by step 55 wherein a database is provided for storing all completed versions of each file in the programs being developed to thereby provide a stored step-by-step history of the development of each binary file. There is also provided, step 56, an implementation for a user to access any sequential version of any file in the database of step 55.

The running of the process setup in FIG. 2 will now be described with respect to the flowchart of FIG. 3. A determination is made to determine if a developer has requested the last or an initial version of a binary file during an application program development process, step 61. If No, the process is returned to step 61 and such a request is awaited. If Yes, the binary file is provided to the developer, step 62, and changes to the file are tracked. At the completion of the work on the file by the developer, a determination is made, step 63, as to whether there have been changes to the file. If Yes, step 64, a dialog box 65 is displayed to the developer to choose whether he wishes the changes to be entered and a determination is made, step 66, as to whether the developer wishes the changes to be entered. This is a typical developmental step; the developer, after assessing the changes, may decide not to change the program and thereby not change the particular binary file constituting a portion of the program. However, if Yes, the developer wishes to change the program, then, step 67, a bar code ID is assigned to the completed version and the version is stored in the database, step 68. The bar code ID for the version is logged onto a database log, step 69, which may be used to access any version by anyone doing subsequent error correction or debugging. Optionally, the developer working on the file may be provided with the opportunity to enter any comments or annotations, step 72, which may be of help to subsequent developers and particularly to those accessing the binary file for subsequent error correction or debugging. The option to enter annotations may be provided to the developer as a display screen dialog which solicits annotations and gives the developer a data entry screen for such annotations, step 73. At a convenient point after the bar code is logged, step 69, or after No decisions in steps 63 or 66, a determination is made, step 70, as to whether the developer is ending the session. If Yes, the session is exited. If No, the process is returned to step 61 and another binary file request by the developer is awaited.

One of the preferred implementations of the present invention is in application program 40, a program made up of programming steps or instructions resident in RAM 14, FIG. 1. Until required by the computer system, the program instructions may be stored in another readable medium, e.g. in disk drive 20 or in a removable memory such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. In the development of a computer program, a method of recording the history of the sequential development of each of a plurality of binary files forming the program comprising:
developing an initial version of a binary file,
developing a sequential plurality of subsequent changed versions of said binary file,
assigning an identifier to each of the subsequent versions of the binary file, and
storing all of said identified versions of said binary file.

2. The method of claim 1 wherein said identifiers are binary identifiers.

3. The method of claim 2 wherein said binary identifiers are in bar code.

4. The method of claim 2 wherein said step of assigning a binary identifier to a version of a binary file is responsive to the completion of said version of said binary file.

5. The method of claim 4 wherein said step of assigning an identifier is automatically responsive to said completion of said version of said binary file.

6. The method of claim 2 further including the steps of:
enabling a user to select one of said binary identifiers; and
accessing the binary file identified by said binary identifier in response to the selection of said identifier.

7. The method of claim 2 wherein the program being developed is a computer operating system.

8. The method of claim 4 further including the step of enabling the user to annotate said completed version of said binary file with comments.

9. A computer program having code recorded on a computer readable medium for recording the history of the sequential development of each of a plurality of binary files forming a program under development, said computer program comprising:
means for developing an initial version of a binary file,
means for developing a sequential plurality of subsequent changed versions of said binary file,
means for assigning an identifier to each of the subsequent versions of the binary file, and
means for storing all of said identified versions of said binary file.

10. The computer program of claim 9 wherein said identifiers are binary identifiers.

11. The computer program of claim 10 wherein said binary identifiers are in bar code.

12. The computer program of claim 10 wherein said means for assigning a binary identifier to a version of a binary file are responsive to the completion of said version of said binary file.

13. The computer program of claim 12 wherein said means for assigning an identifier are automatically responsive to said completion of said version of said binary file.

14. The computer program of claim 13 further including:
means for enabling a user to select one of said binary identifiers; and
means for accessing the binary file identified by said binary identifier in response to the selection of said identifier.

15. The computer program of claim 10 wherein the program being developed is a computer operating system.

16. The computer program of claim 13 further including means for enabling the user to annotate said completed version of said binary file with comments.

17. In a computer controlled system for the development of computer programs, a system for recording the history of the sequential development of each of a plurality of binary files forming a program under development comprising:
means for developing an initial version of a binary file,
means for developing a sequential plurality of subsequent changed versions of said binary file,
means for assigning an identifier to each of the subsequent versions of the binary file, and
means for storing all of said identified versions of said binary file.

18. The computer controlled system of claim 17 wherein said identifiers are binary identifiers.

19. The computer controlled system of claim 18 wherein said binary identifiers are in bar code.

20. The computer controlled system of claim 18 wherein said means for assigning a binary identifier to a version of a binary file are responsive to the completion of said version of said binary file.

21. The computer controlled system of claim 20 wherein said means for assigning an identifier are automatically responsive to said completion of said version of said binary file.

22. The computer controlled system of claim 21 further including:
means for enabling a user to select one of said binary identifiers; and
means for accessing the binary file identified by said binary identifier in response to the selection of said identifier.

23. The computer controlled system of claim 18 wherein the program being developed is a computer operating system.

24. The computer controlled system of claim 21 further including means for enabling the user to annotate said completed version of said binary file with comments.
